(19) United States
(12) Patent Application Publication
(10) Pub. No.: US 2017/0205117 A1
(43) Pub. Date: Jul. 20, 2017

(54) THERMAL INSULATION COMPOSITE FOR SOLAR THERMAL TOWER, SOLAR THERMAL TOWER AND ENERGY GENERATION SYSTEM

(71) Applicant: UNIFRAX I LLC, Tonawanda, NY (US)

(72) Inventors: Joseph A. FERNANDO, Amherst, NY (US); Brian R. BRADLEY, Lockport, NY (US); Greg S. WAZNY, Cheektowaga, NY (US)

(21) Appl. No.: 15/406,276

(22) Filed: Jan. 13, 2017

Related U.S. Application Data
(60) Provisional application No. 62/279,957, filed on Jan. 18, 2016.

(51) Int. Cl. F24J 2/07; B32B 7/08; B32B 15/12; B32B 29/02

(52) U.S. Cl. CPC F24J 2/07; B32B 29/02; B32B 7/08; B32B 15/12; B32B 2307/304; B32B 2262/10; F24J 2002/0038

(57) ABSTRACT

A thermal insulation composite for thermally insulating a solar tower includes at least one thermal insulation layer and at least one thermally expandable layer is disclosed. Further disclosed is a solar tower and a solar thermal energy generation system including the thermal insulation composite. The solar thermal energy generation system uses concentrated solar energy to produce electrical energy.

This application claims the benefit of the filing date under 35 U.S.C. §119(e) from U.S. Provisional Application for Patent Ser. No. 62/279,957 filed Jan. 18, 2016, which is incorporated by reference in its entirety.

### TECHNICAL FIELD

This disclosure is directed to a thermal insulation composite for a solar tower of an thermal energy generation system.

### BACKGROUND

Concentrated solar power systems generate electrical power by collecting solar thermal energy from the sun with mirrors or lenses and concentrating the solar thermal energy onto a solar energy receiver that sits atop a solar tower. The solar energy receiver is generally a boiler containing water. The concentrated solar thermal energy converts the liquid water in the boiler into steam. The generated stream is transferred to an electrical power generator, such as a steam-powered turbine to produce electricity.

The solar tower must be sufficiently thermally insulated from the solar energy concentrated onto the tower by the mirrors or lenses in order to protect the structural integrity of the solar tower and the overall solar thermal energy generation system. To this end, it is known to attach thermal insulation panels made from refractory ceramic fiber to portions of the tower in the area where the solar thermal energy is concentrated in order to shield or otherwise insulate the tower.

The thermal insulation panels attached to the solar thermal towers experience severe thermal cycling and weathering during normal use. In a typical 24 hour period, it is not uncommon for the thermal insulation panels to experience temperatures as hot as 700 to 900° C. during daytime peak sunlight hours to temperatures of 0° C. and below during the night. This extreme temperature range makes it difficult to design thermal insulation systems that are able to withstand the extreme temperatures, thermal expansion, and thermal cycling of the system.

What is needed in the art is a thermal insulation system for the solar thermal energy tower and energy generation system that is able to withstand large fluctuations in temperatures experienced by the solar tower.

### SUMMARY

Provided is a thermal insulation composite for a solar tower comprising a support layer, at least one thermal insulation layer adjacent to said support layer, and a thermally expandable layer adjacent said at least one thermal insulation layer.

According to certain illustrative embodiments, provided is a thermal insulation composite for a solar tower comprising a support layer, a thermal insulation paper layer, a thermal insulation board layer, a thermally expandable gasket layer, and a retaining member.

According to certain illustrative embodiments, the thermal insulation composite comprises, in order, a support layer, a thermal insulation paper layer, a thermal insulation board layer, a thermally expandable gasket layer, and a retaining member.

Also provided is a solar tower comprising a thermal insulation composite attached to the tower, said composite comprising at least one support layer, at least one thermal insulation layer adjacent to said support layer, and a thermally expandable layer adjacent said at least one thermal insulation layer.

According to certain illustrative embodiments, the solar tower comprising a tower and at least one thermal insulation composite attached to the tower, said thermal insulation composite comprising a support layer, a thermal insulation paper layer, a thermal insulation board layer, a thermally expandable gasket layer, and a retaining member.

According to certain illustrative embodiments, said solar tower comprises a tower and at least one thermal insulation system attached to the tower, said thermal insulation composite comprising, in order, a support layer, a thermal insulation paper layer, a thermal insulation board layer, a thermally expandable gasket layer, and a retaining member.

Further provided is a solar thermal power generation system comprising at least one heliostat, a tower, a solar energy receiver positioned near the top of said tower, and at least one thermal insulation composite comprising a support layer, at least one thermal insulation layer adjacent to said support layer, and a thermally expandable layer adjacent said at least one thermal insulation layer.

According to certain illustrative embodiments, the solar thermal power generation system comprising at least one heliostat, a tower, a solar energy receiver positioned near the top of said tower, and at least one thermal insulation composite attached to the tower, said thermal insulation composite comprising a support layer, a thermal insulation paper layer, a thermal insulation board layer, a thermally expandable gasket layer, and a retaining member.

According to certain illustrative embodiments, said solar thermal power generation system comprises at least one heliostat, a tower, a solar energy receiver positioned near the top of said tower, and at least one thermal insulation system attached to the tower, the thermal insulation composite comprising, in order, a support layer, a thermal insulation paper layer, a thermal insulation board layer, a thermally expandable gasket layer, and a retaining member.

### BRIEF DESCRIPTION OF THE DRAWINGS

FIG. 1 is a cross-section of an illustrative embodiment of the thermal insulation composite.

FIG. 2A is a side view of an illustrative embodiment of the thermal insulation composite prior to expansion of the composite fastener.

FIG. 2B is a side view of an illustrative embodiment of the thermal insulation composite showing expansion of the composite fastener and the thermally insulating expandable gasket layer.

FIG. 3 is a schematic representation of a solar tower with surrounding solar field.

FIG. 4 is a graph showing the residual holding force of a prior art thermal insulation composite.

FIG. 5 is a graph showing the residual holding force of a prior art thermal insulation composite.

FIG. 6 is a graph showing the residual holding force of a prior art thermal insulation composite.

FIG. 7 is a graph showing the residual holding force of one illustrative embodiment of the disclosed thermal insulation composite.

### DETAILED DESCRIPTION

The thermal insulation composite for a solar tower and concentrated solar thermal energy generation system comprises a multiple layer composite assembly. The thermal insulation composite for a solar tower comprises a support layer, at least one thermal insulation layer adjacent to said support layer, and a thermally expandable layer adjacent said at least one thermal insulation layer. According to certain illustrative embodiments, The thermal insulation composite for a solar tower comprises a support layer, a thermal insulation paper layer, a thermal insulation board layer, a thermally expandable gasket layer, and a retaining member.

According to certain illustrative embodiments, the thermal insulation composite comprises, in order, a support layer, a thermal insulation paper layer, a thermal insulation board layer, a thermally expandable gasket layer, and a retaining member. According to other illustrative embodiments, there can be other interposed or interleaved layers between one or more of the thermal insulation paper layer and the thermal insulation board layer, or between the thermal insulation board layer and the thermally expandable gasket layer, or between the thermally expandable gasket layer and the retaining member. For example, and without limitation, thermal insulation blankets and/or metal foil layers may be interposed between the support, paper, board, and/or gasket layers.

Each of the thermal insulation paper layer, thermal insulation board layer, and thermally expandable gasket layer may independently be comprised of several sub-layers that collectively comprise the layer.

For example, and only by way of illustration, the thermal insulation paper layer may be comprised of one thermal insulation paper or may be comprised of more than one thermal insulation paper that collectively comprise the thermal insulation paper layer. According to certain illustrative embodiments, the thermal insulation paper layer is comprised of a single thermal insulation paper of a desired thickness and geometry.

For example, and only by way of illustration, the thermal insulation board layer may be comprised of one thermal insulation board or may be comprised of more than one thermal insulation board that collectively comprise the thermal insulation board layer. According to certain illustrative embodiments, the thermal insulation board layer is comprised of a single thermal insulation board of a desired thickness and geometry.

For example, and only by way of illustration, the thermally expandable gasket layer may be comprised of one the thermally expandable gasket or may be comprised of more than one the thermally expandable gasket that collectively comprise the thermally expandable gasket layer. According to certain illustrative embodiments, the thermally expandable gasket layer is comprised of a single the thermally expandable gasket of a desired thickness and geometry.

According to certain illustrative embodiments, thermal insulation comprises a base or support layer having a least one opening to cooperate with or engage a fastener. A thermal insulation paper layer is disposed or otherwise positioned adjacent to the support layer. A thermal insulation board is disposed or otherwise positioned adjacent to the thermal insulation paper layer. A thermally expandable gasket layer is disposed or otherwise positioned adjacent to the thermal insulation board layer. A retaining member is positioned adjacent to the thermally expandable gasket layer. At least one elongated fastener is passed or threaded through the support, paper, board, and gasket layers and the retaining member to affix or otherwise fasten the thermal insulation composite to a solar tower to be thermally insulated, with the support layer adjacent the tower member being thermally insulated.

The thermal insulation composite is incorporated into a solar tower. The solar tower comprises a base and an upwardly extending tower. The tower includes a solar energy receiver positioned at or near the top of the solar tower, and at least one of the presently-disclosed thermal insulation composites attached to a portion of the tower. The thermal insulation composite may be attached or connected at or near the top of the upwardly extending solar tower.

The solar thermal power generation system includes at least one heliostat that is adapted to and is capable of collecting solar energy from the sun and concentrating the solar energy on the solar energy receiver. The solar thermal power generation system also includes an upwardly extending tower having a solar energy receiver positioned at or near the top of the tower that is positioned to receive solar energy from one or more of the heliostats of the energy generation system. According to certain illustrative embodiments, there is a plurality of heliostats that are positioned in an array in a solar energy collection field at least partially surrounding the base or lower end of the solar tower. The heliostats are configured with an angle to capture or collect solar energy from the sun and to concentrate the collected solar energy on the solar receiver that is positioned on the solar energy tower. According to certain embodiments, the heliostats comprise a plurality of mirrors. According to certain embodiments, the heliostats comprise a plurality of lenses.

According to certain illustrative embodiments, the solar energy receiver that is positioned at or near the top of the solar energy tower comprises a water boiler. The water boiler is in fluid communication with a steam-powered turbine. The solar energy collected by the heliostats and concentrated on the water-boiler heats the water contained in the water-boiler to produce steam. The produced steam is transferred to a steam-powered turbine to produce electricity.

The support layer of the thermal insulation composite comprises a base or support plate. The support plate may be a substantially planar plate. Without limitation, and only by way of illustration, the support plate of the thermal insulation composite comprises a metal, a metal alloy, or a composite material. According to certain embodiments, the support plate comprises a metal alloy plate. According to further embodiments, the support plate comprises a steel plate having opposite facing first and second major surfaces. According to further embodiments, the support plate comprising a steel plate includes opposite facing first and second major surfaces, and one or more apertures or openings for accepting a fastener for affixing or fastening the thermal insulation assembly to a solar energy tower. The first major surface faces toward the solar tower and the second major surface faces away from the solar tower. The support layer possesses a sufficient rigidity to support the thermal insulation board to minimize or prevent wind-driven cracking of the board.

The thermal insulation paper layer comprises opposite facing first and second major surfaces. The first major surface of the thermal insulation paper layer is positioned adjacent to the second major surface of the support layer. The thermal insulation paper may be prepared from thermally insulating fibrous materials and optionally a binder for the fibers.

The thermal insulation board layer comprises opposite facing first and second major surfaces. The first major surface of the thermal insulation board layer is positioned adjacent to the second major surface of the thermal insulation paper. The thermal insulation board may be prepared from thermally insulating fibrous materials. Without limitation, a suitable thermal insulation board is commercially available from Unifrax I LLC (Tonawanda, N.Y., USA) under the designation FIBERFRAX® METEOBOARD®.

The thermally expanding gasket layer comprises opposite facing first and second major surfaces. The first major surface of the thermally insulating gasket layer is positioned adjacent to the second major surface of the thermal insulation board layer. The thermally expandable gasket may be prepared from thermally insulating fibrous materials, a thermally expandable material, and optionally a binder. Without limitation, a suitable thermally expanding gasket material is commercially available from Unifrax I LLC (Tonawanda, N.Y., USA) under the registered trademark ISOMAX®.

Any heat resistant inorganic fibers may be utilized in the thermal insulation paper or thermal insulation board so long as the fibers can withstand the paper and board forming process, and can withstand the temperature extremes experienced during normal operation of the solar tower and energy generation system. Without limitation, suitable inorganic fibers that may be used include high alumina polycrystalline fibers, refractory ceramic fibers such as alumino-silicate fibers, alumina-magnesia-silica fibers, kaolin fibers, alkaline earth silicate fibers such as calcia-magnesia-silica fibers and magnesia-silica fibers, S-glass fibers, S2-glass fibers, E-glass fibers, quartz fibers, silica fibers and combinations thereof.

According to certain illustrative embodiments, the heat resistant inorganic fibers comprise ceramic fibers. Without limitation, suitable ceramic fibers include alumina fibers, alumina-silica fibers, alumina-silica-magnesia fibers, alumina-zirconia-silica fibers, zirconia-silica fibers, zirconia fibers and similar fibers. A useful alumina-silica ceramic fiber is commercially available from Unifrax I LLC (Tonawanda, N.Y., USA) under the registered trademark FIBERFRAX®. The FIBERFRAX® ceramic fibers comprise the fiberization product of about 45 to about 75 weight percent alumina and about 25 to about 55 weight percent silica. The FIBERFRAX® fibers exhibit operating temperatures of up to about 1540° C. and a melting point up to about 1870° C.

The alumina/silica fiber may comprise from about 40 weight percent to about 60 weight percent Al₂O₃ and about 60 weight percent to about 40 weight percent SiO₂. The fiber may comprise about 50 weight percent Al₂O₃ and about 50 weight percent SiO₂. The alumina/silica/magnesia glass fiber typically comprises from about 64 weight percent to about 66 weight percent SiO₂, from about 24 weight percent to about 25 weight percent Al₂O₃, and from about 9 weight percent to about 10 weight percent MgO. The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weigh percent Al₂O₃, 7 weight percent B₂O₃, 3 weight percent MgO, 19 weight percent CaO and traces of the above mentioned materials.

Without limitation, suitable examples of biosoluble alkaline earth silicate fibers that can be used include those fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, all of which are incorporated herein by reference.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the alkaline earth silicate fibers comprise the fiberization product of about 65 to about 86 weight percent silica, about 14 to about 35 weight percent magnesia and 5 weight percent or less impurities. According to other embodiments, the alkaline earth silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Tonawanda, N.Y., USA) under the registered trademark ISOFRAX®. Commercially available ISOFRAX® fibers generally comprise the fiberization product of about 70 to about 80 weight percent silica, about 18 to about 27 weight percent magnesia and 4 weight percent or less impurities.

According to certain embodiments, the biosoluble alkaline earth silicate fibers may comprise the fiberization product of a mixture of oxides of calcium, magnesium and silica. These fibers are commonly referred to as calcia-magnesia-silica fibers. According to certain embodiments, the calcia-magnesia-silicate fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silicate fibers are commercially available from Unifrax I LLC (Tonawanda, N.Y. USA) under the registered trademark INSULFRAX®. INSULFRAX® fibers generally comprise the fiberization product of about 61 to about 67 weight percent silica, from about 27 to about 33 weight percent calcia, and from about 2 to about 7 weight percent magnesia. Other suitable calcia-magnesia-silicate fibers are commercially available from Thermal Ceramics (Augusta, Ga., USA) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

The expanding material of the thermally expanding gasket material may be selected from unexpanded vermiculite, expandable graphite, hydrobiotite, water-swelling tetrasilicic flourine mica, alkaline metal silicates, or mixtures thereof. According to certain embodiments, the expanding material is unexpanded vermiculite.

The thermal insulation paper and board, and thermally expanding gasket, may include one or more inorganic binder(s), one or more organic binder(s), or a combination of one or more inorganic binder(s) and one or more organic binder(s).

Without limitation, suitable inorganic binders may include colloidal dispersions of alumina, silica, zirconia, and mixtures thereof. The organic binder(s) may be provided as a solid, a liquid, a solution, a dispersion, a latex, or similar form. Examples of suitable organic binders include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, organic silicones, organofunctional silanes, unsaturated polyesters, epoxy resins, polyvinyl esters (such as polyvinylacetate or polyvinylbutyrate latexes) and the like.

According to certain embodiments, the thermally expandable gasket layer comprises inorganic, low bio-persistent (ie., biosoluble) fibers, thermally expandable material, and a binder.

According to certain embodiments, the thermal insulation composite comprises a thermal insulation paper, thermal insulation board, and thermally expandable gasket comprising low biopersistent, inorganic fibers. According to certain embodiments, the low biopersistent fibers of the thermal insulation paper, thermal insulation board, and thermally expandable gasket comprise alkaline earth silicate fibers. According to certain embodiments, the alkaline earth silicate fibers of the thermal insulation paper, thermal insulation board, and thermally expandable gasket comprise magnesium-silicate fibers.

According to certain embodiments, the thermal insulation composite comprise a thermal insulation paper, thermal insulation board, and thermally expandable gasket comprise ceramic fibers. According to certain embodiments, the ceramic fibers of the thermal insulation paper, thermal insulation board, and thermally expandable gasket comprise alumino-silicate fibers. According to certain embodiments, the alumino-silicate fibers of the thermal insulation paper, thermal insulation board, and thermally expandable gasket comprise from about 45 to about 55 weight percent alumina and from about 55 to about 45 weight percent silica.

According to certain embodiments, the thermal insulation assembly comprises a thermal insulation paper and thermally expandable gasket comprising low biopersistent inorganic fibers, and a thermal insulation board comprising ceramic fibers. According to certain embodiments, the low biopersistent fibers of the thermal insulation paper and thermally expandable gasket comprise alkaline earth silicate fibers. According to certain embodiments, the alkaline earth silicate fibers of the thermal insulation paper and thermally expandable gasket comprise magnesium-silicate fibers. The ceramic fibers of the thermal insulation board comprise alumino-silicate fibers.

According to certain illustrative embodiments, the perimeter of support layer, the thermal insulation paper layer, and thermal insulation board layer are substantially coextensive. According to certain illustrative embodiments, the perimeter of the support layer, the thermal insulation paper layer, and thermal insulation board layer are coextensive.

According to certain illustrative embodiments, the perimeter of thermally expanding gasket layer and the retaining member are substantially coextensive. According to certain illustrative embodiments, the perimeter of thermally expanding gasket layer and the retaining member are coextensive.

According to certain illustrative embodiments, the perimeter of the support layer, the thermal insulation paper layer, and the thermal insulation board layer are substantially coextensive, and the perimeter of thermally expanding gasket layer and the retaining member are substantially coextensive, with the perimeters of the thermally expanding gasket layer and the retaining member being smaller than the support layer, the thermal insulation paper, and thermal insulation board.

According to certain illustrative embodiments, the perimeter of support layer, the thermal insulation paper layer, and thermal insulation board layer are coextensive, and the perimeter of thermally expanding gasket layer and the retaining member are coextensive, with the perimeters of the thermally expanding gasket layer and the retaining member being smaller than the support layer, the thermal insulation paper, and thermal insulation board.

According to certain embodiments, the retaining member of the thermal insulation composite includes a substantially circular retaining member. According to certain embodiments, the thermally expanding gasket of the thermal insulation system is substantially circular. The outer circumference of the thermally expandable gasket is substantially coextensive with the outer circumference of the circular retaining member.

The thermally insulating expanding gasket of the thermally insulating expanding gasket layer of the composite comprises a thickness that is defined by the opposite facing first and second major surfaces. In order to accommodate the expansion and contraction experienced by the solar thermal energy generation system as a result of thermal cycling, the thermally insulating expanding gasket is installed in the thermal insulation composite under compression.

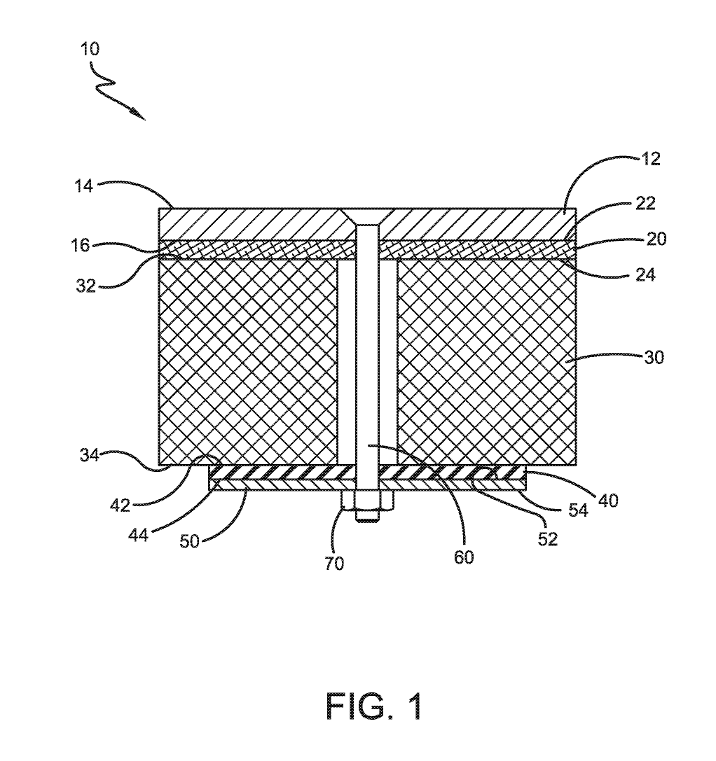

FIG. 1 shows a cross-sectional view of an illustrative embodiment of a thermal insulation system 10 for a solar thermal tower and energy generation system. The system 10 includes a support plate 12, such as a steel support plate. Steel support plate 12 includes opposite facing first 14 and second 16 major surfaces. Adjacent second major surface 16 of the steel support plate 12 is a thermal insulation paper layer 20. Thermal insulation paper 20 includes opposite facing first 22 and second 24 major surfaces. Adjacent second major surface 24 of thermal insulation paper 20 is thermal insulation board 30. Thermal insulation board 30 includes opposite facing first 32 and second 34 major surfaces. Adjacent second major surface 34 of thermal insulation board 30 is thermally expanding gasket 40. Thermally expanding gasket 40 includes opposite having first 42 and second 44 major surfaces. The thermally expanding gasket 40 is shown in this illustrative embodiment as having a dimension that is smaller than a dimension of the support plate 12 and the thermally insulating paper 20 and board 30. A retaining member 50 having opposite facing first 52 and second 54 major surfaces is positioned adjacent the second major surface 44 of the thermally expanding gasket 40. An elongated fastener 60 is passed through the support plate 12, thermal insulation paper 20 and board 30, thermally expanding gasket 40 and retaining member 50, and is fastened with nut 70. According to the embodiment shown in FIG. 1, the thermally expanding gasket 40 is compressed between the thermal insulation board 30 and the retaining member 50 by the cooperative tightening of the fastener 60 and nut 70.

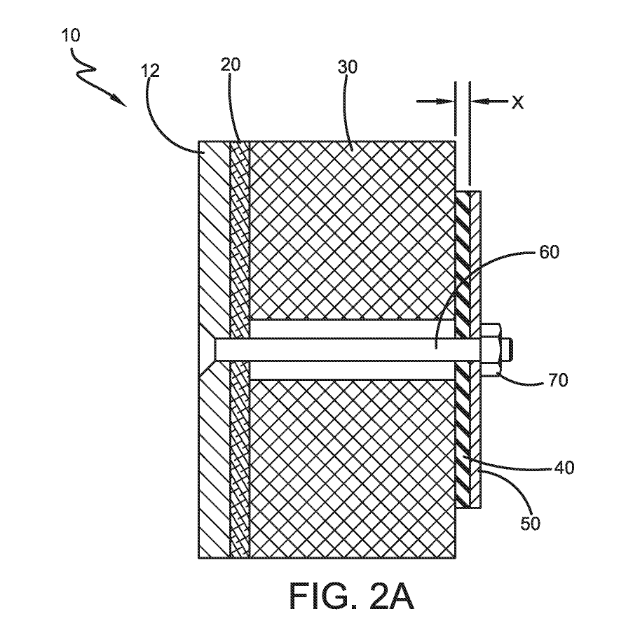

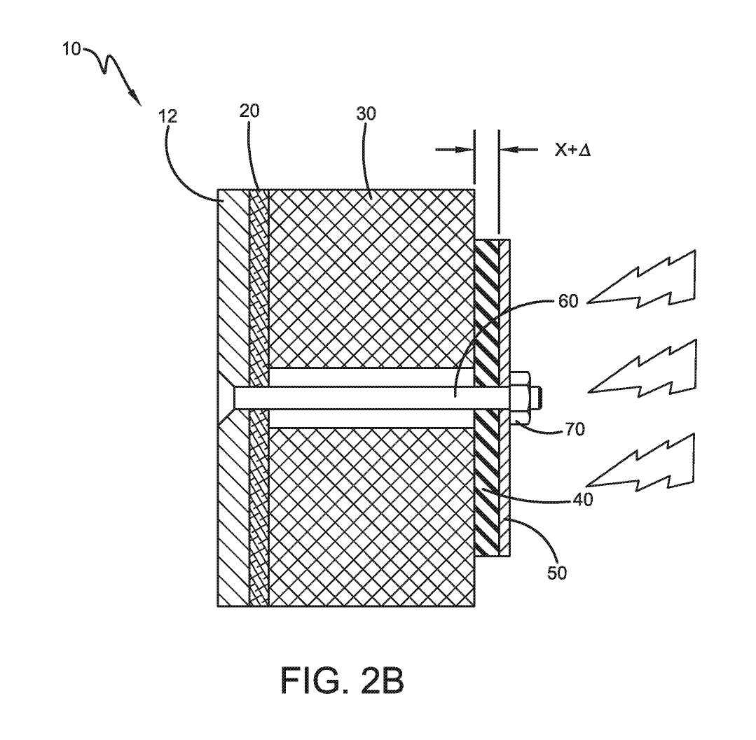

FIG. 2A shows a side view of an illustrative embodiment of a thermal insulation system 10 for a solar thermal tower and energy generation system prior to thermal expansion of the elongated fastener (ie, bolt). As shown in FIG. 2A, prior to thermal expansion of the elongated fastener, the thickness of the thermally expandable gasket layer is represented by “x”.

FIG. 2B shows another side view of an illustrative embodiment of a thermal insulation system 10 for a solar thermal tower and energy generation system after thermal expansion of the elongated fastener (ie, bolt). As shown in FIG. 2B, after thermal expansion of the elongated fastener, the thickness of the thermally expandable gasket layer is greater than is represented by “x+Δ”.

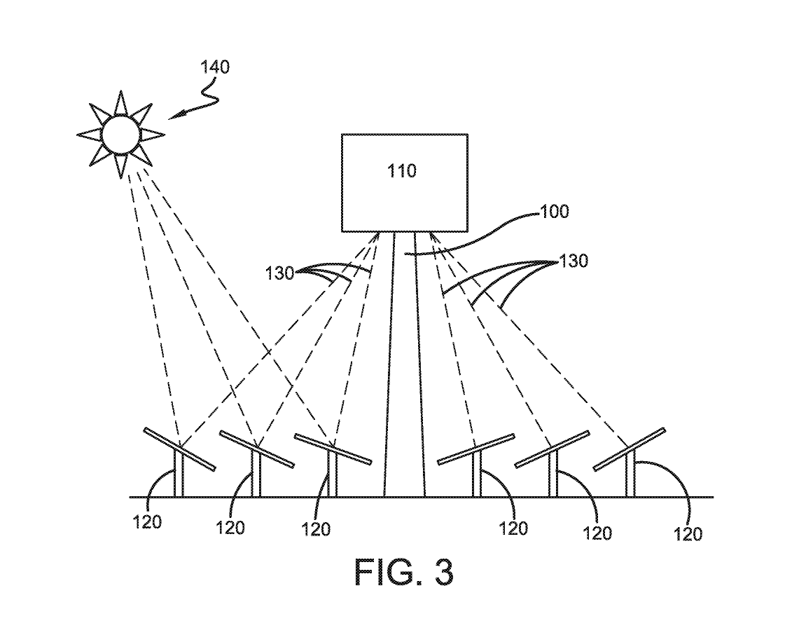

FIG. 3 shows an illustrative embodiment of the solar tower and solar field. Solar tower 100 includes a solar receiver 110 positioned at the top of the tower 100. A plurality of heliostats 120 are positioned in an array in a solar energy collection field surrounding the solar tower 100. Solar energy 130 from the sun 140 is captured or collected by the heliostats 120 and is concentrated on the solar energy receiver 110 at the top of the solar tower 100.

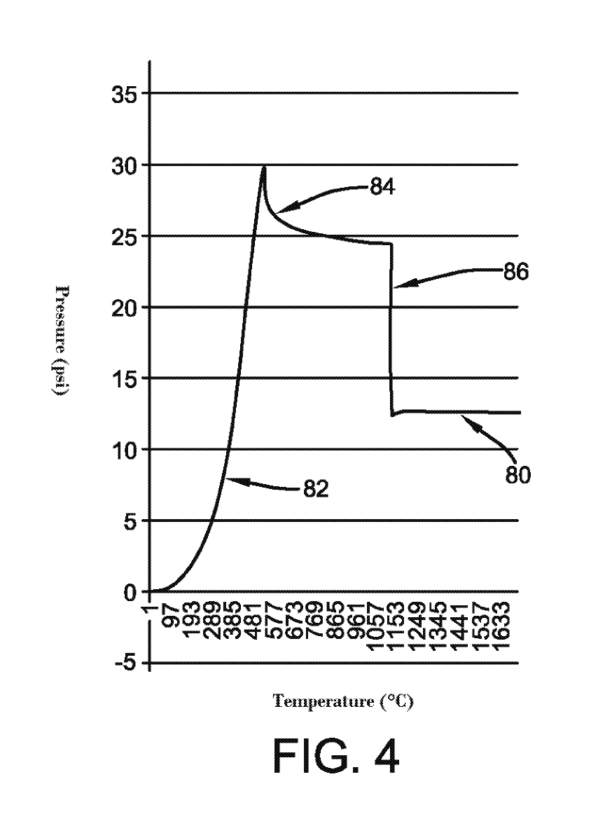

FIG. 4 shows the residual holding force 80 of a prior art system without a thermally expanding gasket layer. The graph shows the initial force 82, followed by the relaxation time 84, followed by a period of thermal expansion 86, followed by a final residual holding force 80. Comparative Example 1 of FIG. 4 comprises a thermal insulation composite comprising a layer of METEOBOARD® thermal insulation board and a 13 mm thick thermal insulating blanket.

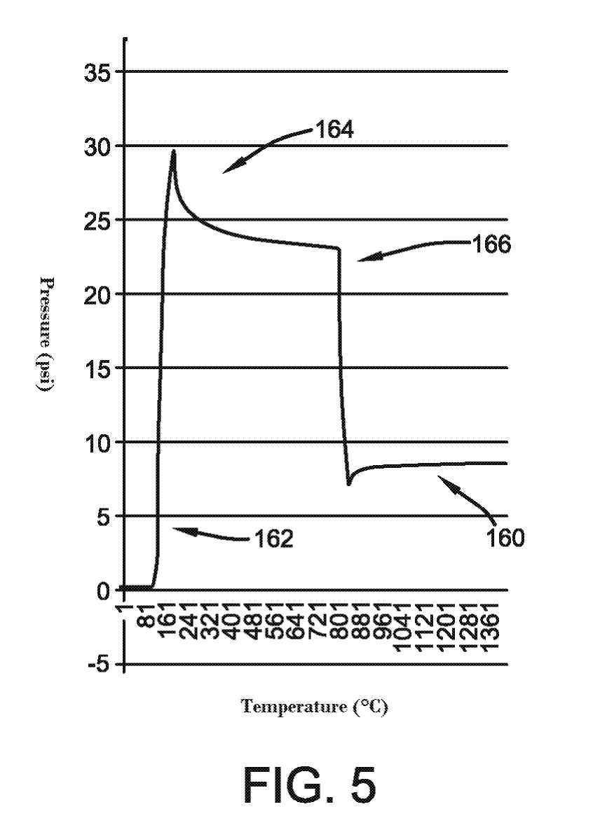

FIG. 5 shows the residual holding force 160 of a prior art system with paper but without a thermally expanding gasket layer. The graph shows the initial force 162, followed by the relaxation time 164, followed by a period of thermal expansion 166, followed by a final residual holding force 160. Comparative Example 2 of FIG. 5 comprises a thermal insulation composite comprising a layer of METEOBOARD® with paper and a 0.5 mm bolt expansion.

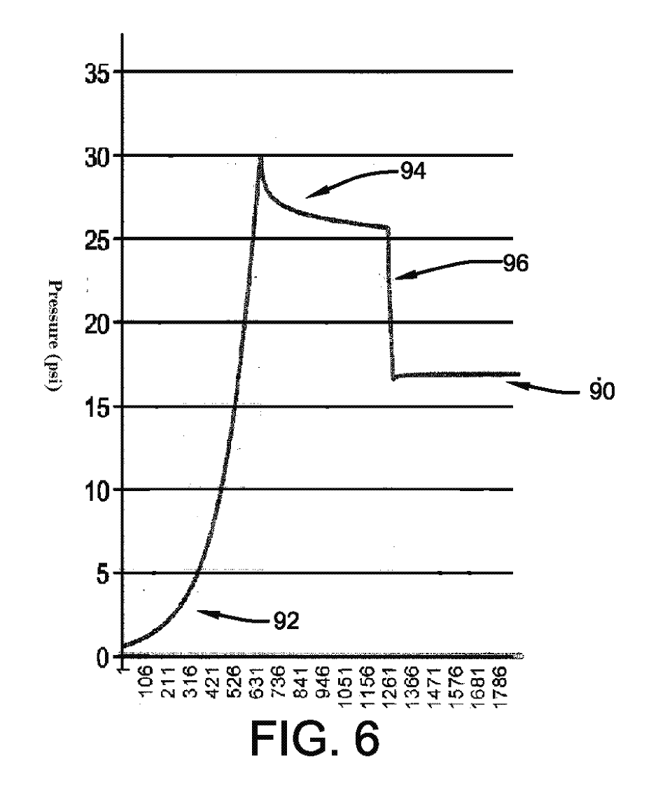

FIG. 6 shows the residual holding force 90 of the presently disclosed thermal insulation system with a thermally expanding gasket layer. The graph shows the initial force 92, followed by the relaxation time 94, followed by a period of thermal expansion 96, followed by a final residual holding force 90. Inventive Example 3 of FIG. 6 comprises a thermal insulation composite comprising a layer of METEOBOARD® thermal insulation board, a thermal insulating blanket, and a thermally expanding gasket. As shown in FIG. 6, the inventive thermal insulation composite exhibits a residual holding force that is greater than the residual holding force of the comparative systems of FIG. 4.

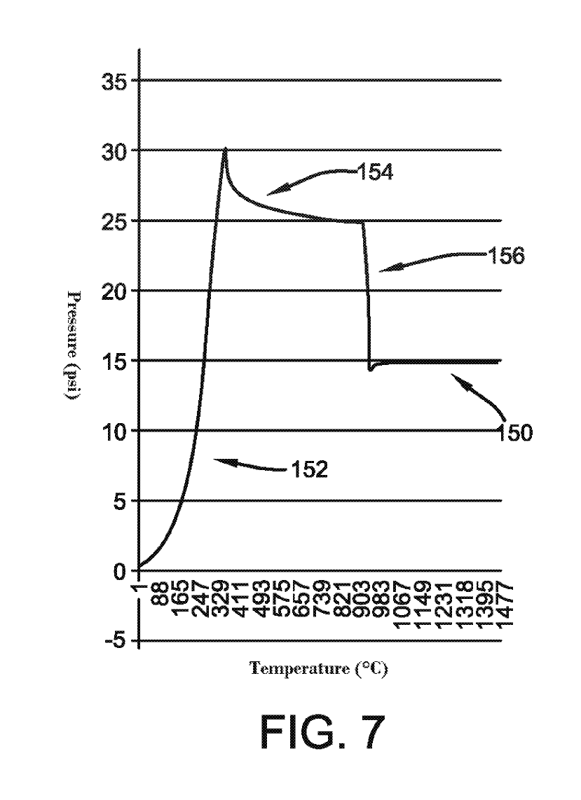

FIG. 7 shows the residual holding force 154 of an illustrative embodiment of the thermal insulation composite comprising a layer of METEOBOARD® thermal insulation board, a layer of a thermal insulating paper, and a layer of a thermally expanding gasket commercially available from Unifrax under ISOMAX®. The graph shows the initial force 152, followed by the relaxation time 154, followed by a period of thermal expansion 156, followed by a final residual holding force 80. As shown in FIG. 7, the inventive thermal insulation composite exhibits a residual holding force that is greater than the residual holding force of the comparative systems of FIG. 5.

While the thermal insulation composite, solar tower, solar energy system, and method have been described in connection with various illustrative embodiments, it is to be understood that other similar embodiments may be used or modifications and additions may be made to the described embodiments for performing the same function. Furthermore, the various illustrative embodiments may be combined to produce the desired results. Therefore, thermal insulation system, solar tower and solar energy system should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A thermal insulation composite comprising:
a support layer;
a thermal insulation layer; and
a thermally expandable gasket member.

2. The thermal insulation support layer of claim 1, wherein the thermal insulation layer comprises a thermal insulation paper layer and a thermal insulation board layer.

3. The thermal insulation support layer of claim 1, comprising a retaining member.

4. The thermal insulation composite of claim 3 comprising, in order:
said support layer;
said thermal insulation paper layer;
said thermal insulation board layer;
said thermally expandable gasket layer;
said retaining member; and
at least one elongated fastener passing through said support, paper, board and gasket layers and said retaining member.

5. The thermal insulation composite of claim 4, wherein said support layer comprises a support plate.

6. The thermal insulation composite of claim 5, wherein said support plate comprises a metal, a metal alloy or a composite material.

7. The thermal insulation composite of claim 6, wherein said metal alloy comprises steel.

8. The thermal insulation composite of claim 6, wherein said thermal insulation board comprises inorganic fibers selected from the group consisting of high alumina polycrystalline fibers, ceramic fibers, mullite fibers, glass fibers, biosoluble fibers, quartz fibers, silica fibers, and combinations thereof.

9. The thermal insulation composite of claim 8, wherein said high alumina polycrystalline fibers comprise the fiberization product of about 72 to about 100 weight percent alumina and about 0 to about 28 weight percent silica.

10. The thermal insulation system of claim 8, wherein said ceramic fibers comprise alumino-silicate fibers comprising the fiberization product of about 45 to about 72 weight percent alumina, and about 28 to about 55 weight percent silica.

11. The thermal insulation composite of claim 8, wherein said biosoluble fibers comprise magnesia-silica fibers comprising the fiberization product of about 65 to about 86 weight percent silica, from about 14 to about 35 weight percent magnesia, and about 5 weight percent of less impurities.

12. The thermal insulation composite of claim 8, wherein said magnesia-silica fibers comprise the fiberization product of about 70 to about 86 weight percent silica, about 14 to about 30 weight percent magnesia, and about 5 weight percent or less impurities.

13. The thermal insulation composite of claim 12, wherein said magnesia-silica fibers comprise the fiberization product of about 70 to about 80 weight percent silica, about 18 to about 27 weight percent magnesia, and 0 to 4 weight percent impurities.

14. The thermal insulation composite of claim 8, wherein said biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

15. The thermal insulation composite of claim 14, wherein said calcia-magnesia-silica fibers comprise the fiberization product of about 60 to about 70 weight percent silica, from about 16 to about 35 weight percent calcia, and from about 4 to about 19 weight percent magnesia.

16. The thermal insulation composite of claim 15, wherein said calcia-magnesia-silica fibers comprise the fiberization product of about 61 to about 67 weight percent silica, from about 27 to about 33 weight percent calcia, and from about 2 to about 7 weight percent magnesia.

17. The thermal insulation composite of claim 7, wherein said thermal insulation paper comprises inorganic fibers selected from the group consisting of high alumina polycrystalline fibers, ceramic fibers, mullite fibers, glass fibers, biosoluble fibers, quartz fibers, silica fibers, and combinations thereof.

18. The thermal insulation composite of claim 17, wherein said high alumina polycrystalline fibers comprise the fiberization product of about 72 to about 100 weight percent alumina and about 0 to about 28 weight percent silica.

19. The thermal insulation composite of claim 17, wherein said ceramic fibers comprise alumino-silicate fibers comprising the fiberization product of about 45 to about 72 weight percent alumina, and about 28 to about 55 weight percent silica.

20. The thermal insulation composite of claim 17 wherein said biosoluble fibers comprise magnesia-silica fibers comprising the fiberization product of about 65 to about 86 weight percent silica, from about 14 to about 35 weight percent magnesia, and about 5 weight percent of less impurities.

21. The thermal insulation composite of claim 17, wherein said magnesia-silica fibers comprise the fiberization product of about 70 to about 86 weight percent silica, about 14 to about 30 weight percent magnesia, and about 5 weight percent or less impurities.

22. The thermal insulation composite of claim 21, wherein said magnesia-silica fibers comprise the fiberization product of about 70 to about 80 weight percent silica, about 18 to about 27 weight percent magnesia, and 0 to 4 weight percent impurities.

23. The thermal insulation composite of claim 17, wherein said biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

24. The thermal insulation composite of claim 23, wherein said calcia-magnesia-silica fibers comprise the fiberization product of about 60 to about 70 weight percent silica, from about 16 to about 35 weight percent calcia, and from about 4 to about 19 weight percent magnesia.

25. The thermal insulation composite of claim 24, wherein said calcia-magnesia-silica fibers comprise the fiberization product of about 61 to about 67 weight percent silica, from about 27 to about 33 weight percent calcia, and from about 2 to about 7 weight percent magnesia.

26. The thermal insulation composite of claim 17, wherein said thermally expandable gasket layer comprises inorganic fibers, intumescent material, and a binder.

27. The thermal insulation composite of claim 26, wherein said inorganic fibers are selected from the group consisting of high alumina polycrystalline fibers, ceramic fibers, mullite fibers, glass fibers, biosoluble fibers, quartz fibers, silica fibers, and combinations thereof.

28. The thermal insulation composite of claim 27, wherein said inorganic fibers comprise low biopersistant alkaline earth silicate wool fibers.

29. The thermal insulation composite of claim 28, wherein said intumescent material is selected from the group consisting of unexpanded vermiculite, expandable graphite, hydrobiotite, water-swelling tetrasilicic flourine mica, alkaline metal silicates, or mixtures thereof.

30. The thermal insulation composite of claim 29, wherein said intumescent material comprises unexpanded vermiculite.

31. The thermal insulation composite of claim 30, wherein said retaining member comprises a washer.

32. A solar energy tower comprising:
a tower; and
at least one thermal insulation composite as claimed in claim 4, wherein said thermal insulation composite is attached to the tower.

33. A solar thermal power generation system comprising:
at least one heliostat;
a tower;
a solar energy receiver positioned near the top of said tower; and
at least one thermal insulation composite as claimed in claim 4, wherein said thermal insulation composite is attached to the tower.

34. The solar thermal power generation system of claim 31, comprising a plurality of heliostats arranged in an array in a solar energy collection field.

35. The solar thermal power generation system of claim 34, wherein said plurality of heliostats are mirrors.

36. The solar thermal power generation system of claim 35, wherein said receiver comprises a water boiler.

37. The solar thermal power generation system of claim 36, wherein said water boiler is in fluid communication with a steam-powered turbine.
